(19) United States
(12) Patent Application Publication
(10) Pub. No.: US 2015/0160917 A1
(43) Pub. Date: Jun. 11, 2015

(54) DISPLAY APPARATUS AND CONTROLLING METHOD THEREOF

(71) Applicant: SAMSUNG ELECTRONICS CO., LTD., Suwon-si (KR)

(72) Inventors: Dong-Hun LEE, Suwon-si (KR); Jung-geun KIM, Suwon-si (KR)

(73) Assignee: SAMSUNG ELECTRONICS CO., LTD., Suwon-si (KR)

(21) Appl. No.: 14/521,704

(22) Filed: Oct. 23, 2014

(30) Foreign Application Priority Data
Dec. 6, 2013 (KR) 10-2013-0151356

(51) Int. Cl. G06F 3/16; G06F 3/0484; G06F 3/0481

(52) U.S. Cl. CPC G06F 3/167; G06F 3/04817; G06F 3/04842; G06F 3/04847

(57) ABSTRACT

A display apparatus and a controlling method thereof are provided. The method for controlling a display apparatus includes displaying at least one display item and a cursor on a display screen; when a predetermined user motion is input while the cursor is located at one of the at least one display item, displaying voice guide information corresponding to the one of the at least one display item where the cursor is located; and when a user voice is input based on the voice guide information while the predetermined user motion is maintained, controlling the one of the at least one display item according to the input user voice.

### CROSS-REFERENCE TO RELATED APPLICATION

This application claims priority from Korean Patent Application No. 10-2013-0151356, filed on Dec. 6, 2013, in the Korean Intellectual Property Office, the disclosure of which is incorporated herein by reference in its entirety.

### BACKGROUND

1. Field

Apparatuses and methods consistent with exemplary embodiments relate to a display apparatus and a controlling method thereof, and more particularly, to a display apparatus which is capable of controlling a display item using a user motion and a user voice and a controlling method thereof.

2. Description of the Related Art

Recently, display apparatuses such as a smart television may be controlled not only by a user command which is input through a remote controller but also by a user command which is input through a motion input apparatus (for example, a camera) or a voice input apparatus (for example, a microphone).

To execute the function of a display apparatus through a user voice or a user motion, a voice task mode or a motion task mode is provided. That is, a related art display apparatus recognizes a motion of a body part such as a finger or an arm of a user, which is photographed by a camera, and controls the function of the display apparatus according to the recognized motion, or recognizes a user voice input through a microphone and controls the function of the display apparatus according to the recognized voice. In this case, the voice task mode and the motion task mode are separately operated according to different user inputs through a user interface (UI) provided on a display screen, and are not interlocked with each other.

### SUMMARY

One or more exemplary embodiments provide a display apparatus capable of controlling a display item using a user motion and a user voice, and a controlling method thereof.

According to an aspect of an exemplary embodiment, provided is a method for controlling a display apparatus including: displaying at least one display item and a cursor on a display screen; when a predetermined user motion is input while the cursor is located at one of the at least one display item, displaying voice guide information corresponding to the one of the at least one display item where the cursor is located; and when a user voice is input based on the voice guide information while the predetermined user motion is maintained, controlling the one of the at least one display item according to the input user voice.

When the one of the at least one display item is an item among a plurality of items included in a list, the voice guide information may include at least one text item to control the item.

The controlling may include, when a user voice which matches with one of the at least one text item included in the voice guide information is input while the predetermined user motion is maintained, controlling the display item according to the text item.

When the one of the at least one display item is a widget for providing information, the voice guide information may include a message for guiding a user to control the widget to provide another information.

The method may further include, when the user voice is input based on the voice guide information while the predetermined user motion is maintained, transmitting the user voice to an external server, and when information corresponding to the user voice is received from the server, displaying the received information through the widget.

The method may further include, when the predetermined user motion is released, removing the voice guide information from the display screen.

The displaying the voice guide information may include, when the predetermined user motion is maintained for a predetermined time while the cursor is located at the one of the at least one display item, applying power to a voice input apparatus and displaying the voice guide information corresponding to the one of at least one display item where the cursor is located.

The displaying the at least one display item and the cursor may include displaying the at least one display item, and when a user motion for operating a motion task mode is input, displaying the cursor on the display screen.

The displaying the voice guide information may include displaying an indicator for indicating that the user voice is recognizable on at least a portion of the display screen.

The predetermined user motion may be a pinch or grab motion.

According to an aspect of another exemplary embodiment, provided is a display apparatus including: a display configured to display at least one display item and a cursor on a display screen; a motion inputter configured to receive a user motion; a voice inputter configured to receive a user voice; and a controller configured to, when a predetermined user motion is input through the motion inputter while the cursor is located at one of the at least one display item, control the display to display voice guide information corresponding to the one of the at least one display item where the cursor is located, and when a user voice is input based on the voice guide information through the voice inputter while the predetermined user motion is maintained, control the one of the at least one display item according to the input user voice.

When the one of the at least one display item is an item among a plurality of items included in a list, the voice guide information may include at least one text item to control the item.

The controller, when a user voice which matches with one of the at least one text item included in the voice guide information is input through the voice inputter while the predetermined user motion is maintained, may control the one of the at least one display item according to the one of the at least one text item.

When the one of the at least one display item is a widget for providing information, the voice guide information may include a message for guiding a user to control the widget to provide another information.

The apparatus may further include a communicator, and the controller, when the user voice is input based on the voice guide information through the voice inputter while the predetermined user motion is maintained, may control the communicator to transmit the user voice to an external server, and when information corresponding to the user voice is received from the external server, control the display to display the received information through the widget.

The controller, when the predetermined user motion is released, may control the display to remove the voice guide information from the display screen.

The controller, when the predetermined user motion is maintained for a predetermined time while the cursor is located at the one of the at least one display item, may control the display to apply power to the voice inputter and display the voice guide information corresponding to the one of the at least one display item where the cursor is located.

The controller may control the display to display the at least one display item, and when a user motion for operating a motion task mode is input, to display the cursor on the display screen.

The controller may control the display to display an indicator for indicating that the user voice is recognizable on at least a portion of the display screen.

The predetermined user motion may be a pinch or grab motion.

According to an aspect of an exemplary embodiment, provided is a display apparatus including: a display configured to display a display item on a display screen; and a controller configured to select at least one display item displayed on the display screen according to a first command and perform a control operation on the selected at least one display item according to a second command, the first and the second commands being received through detection of at least one from among a motion and a voice of a user, wherein the controller, in response to the first command, controls the display to display guide information for guiding the user to input the second command on the display screen.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a configuration of a display apparatus according to an exemplary embodiment;

FIG. 2 is a block diagram illustrating a detailed configuration of a display apparatus according to an exemplary embodiment;

FIGS. 3A to 3E are views for explaining controlling a display item according to an exemplary embodiment;

FIGS. 4A to 4E are views for explaining controlling a widget according to an exemplary embodiment;

FIGS. 5A to 5F are views for explaining controlling a display item according to another exemplary embodiment;

FIGS. 6A to 6F are views for explaining controlling a display item according to still another exemplary embodiment; and

FIG. 7 is a flowchart illustrating a method for controlling a display apparatus according to an exemplary embodiment.

### DETAILED DESCRIPTION

Certain exemplary embodiments are described in greater detail below with reference to the accompanying drawings.

In the following description, the same drawing reference numerals are used for the same elements even in different drawings. The matters defined in the description, such as detailed construction and elements, are provided to assist in a comprehensive understanding of exemplary embodiments. Thus, it is apparent that exemplary embodiments can be carried out without those specifically defined matters. Also, well-known functions or constructions are not described in detail since they would obscure exemplary embodiments with unnecessary detail.

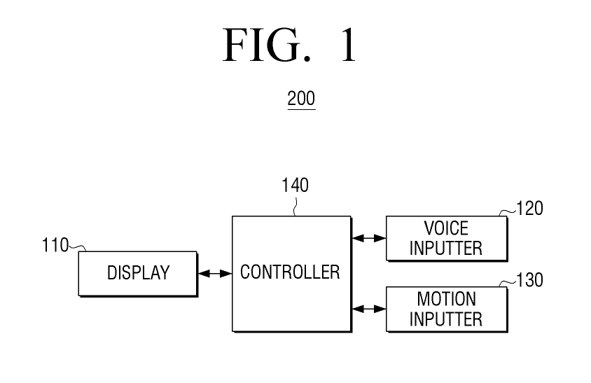

FIG. 1 is a block diagram illustrating a configuration of a display apparatus 100 according to an exemplary embodiment. As illustrated in FIG. 1, the display apparatus 100 includes a display 110, a voice inputter 120, a motion inputter 130, and a controller 140.

The display 110 outputs image data under the control of the controller 140. In particular, the display 110 may display at least one display item and a cursor. In addition, when a predetermined user motion is input, the display 110 may display voice guide information corresponding to a display item where the cursor is currently located.

The voice inputter 120 receives a voice which is uttered by a user. The voice inputter 120 converts the input voice signal to an electrical signal and outputs the converted electrical signal to the controller 140. In this case, the voice inputter 110 may be realized as, for example, a microphone.

The motion inputter 130 receives an image signal (for example, consecutive frames) which is generated by photographing a user motion and provides the received image signal to the controller 140. In this case, the motion inputter 120 may be realized as, for example, a camera comprising a lens and an image sensor.

The controller 140 controls overall operations of the display apparatus 100 according to a user command which is input through the voice inputter 120 and the motion inputter 130. Specifically, when a predetermined user motion (for example, a pinch or grab motion) is input through the motion inputter 130 while a cursor is located at one of at least one display item, the controller 140 may control the display 110 to display voice guide information corresponding to a display item where the cursor is located. When a user voice is input based on voice guide information through the voice inputter 120 while a predetermined user motion is maintained, the controller 140 may control a display item according to the input user voice.

In an exemplary embodiment, the controller 140 may control the display 110 to display a list including at least one text item, as voice guide information, for controlling a display item where a cursor is located. For example, the controller 140 may display a voice guide list including text items of “store”, “delete”, and “information” on at least a portion of at least one display item as voice guide information.

In an exemplary embodiment, when a user voice corresponding to one of at least one text item included in voice guide information is input through the voice inputter 120 while a predetermined motion of the user is maintained, the controller 140 may control a display item according to the text item. For example, a user voice of “delete” is input through the voice inputter 120 while a predetermined user motion is maintained, the controller 140 may delete a display item.

In another exemplary embodiment, when at least one display item includes a widget which provides information, the controller 140 may include a message for guiding a user voice such that the widget may provide another information. For example, when a display item includes a weather widget for informing weather, the controller 140 may control the display 110 to display, as voice guide information, a message such as “please say another name of place” for guiding a user voice to provide weather information of another place.

When a user voice is input based on voice guide information through the voice inputter 120 while a predetermined user motion is maintained, the controller 140 may transmit the user voice to an external server. When information corresponding to the user voice is received from the server, the controller 140 may control the display 110 to display the received information through a widget. For example, when a user voice of “Suwon” is input while a weather widget and voice guide information are displayed, the controller 140 may transmit a signal for requesting weather information regarding a place “Suwon” to a server, and control the display 110 to display weather information regarding the place “Suwon”, which is received from the server, through a widget.

When a predetermined user motion is released while voice guide information is displayed, the controller 140 may control the display 110 to remove the voice guide information from a display screen.

When a predetermined user motion is maintained for a predetermined time while a cursor is located at one of at least one display item, the controller 140 may apply power to the voice inputter 110, and control the display 110 to display voice guide information around a display item where the cursor is located.

In the above exemplary embodiment, a cursor and a display item may be simultaneously displayed, but this is only an example. In an alternative embodiment, when a user motion to operate a motion task mode is input through the motion inputter 130 while at least one display item is displayed, the controller 140 may control the display 110 to display a cursor on a display screen.

When a predetermined user motion is input and thus voice guide information is displayed, the controller 140 may control the display 110 to display an indicator for indicating that a user voice may be recognized on at least a portion of a display screen along with the voice guide information. For example, the controller 140 may control the display 110 to display an indicator including an icon in a form of a microphone along with voice guide information on, for example, an upper portion of a display screen.

Here, the controller 140 may include one or more hardware and/or software components. For example, the controller 140 may include one or more of an integrated circuitry, a dedicated circuit, firmware, and/or a processor such as a central processing unit (CPU) which executes software programs stored in a storage, e.g., a memory.

As described above, according to various exemplary embodiments, a user may control a display item more easily and conveniently.

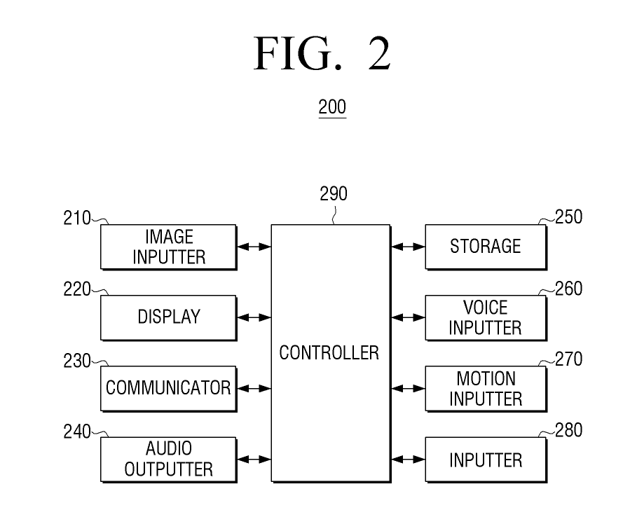

Hereinafter, a display apparatus according to exemplary embodiments will be described in detail with reference to FIGS. 2 to 6F.

FIG. 2 is a block diagram illustrating a detailed configuration of a display apparatus 200 in detail according to an exemplary embodiment. As illustrated in FIG. 2, the display apparatus 200 includes an image inputter 210, a display 220, a communicator 230, an audio outputter 240, a storage 250, a voice inputter 260, a motion inputter 270, an inputter 280, and a controller 290.

FIG. 2 illustrates various components of the display apparatus 200 that provides various functions such as a voice recognition function, a motion recognition function, a communication function, an image receiving function, etc. Accordingly, depending on exemplary embodiments, a part of the components illustrated in FIG. 2 may be omitted or changed, or other components may be further added.

The image inputter 210 receives an image from outside. In particular, the image inputter 210 may receive a broadcast content from an external broadcasting station, and may also receive image contents from an external apparatus (for example, a digital versatile disc (DVD), a personal computer (PC), and a set-top box).

The display 220 may display image data which is received and processed by the image inputter 210. In particular, the display 220 may display at least one from among at least one display item and a cursor. In this case, the at least one display item may be an item included in a list, or a widget which provides information.

When a predetermined user motion is input through the motion inputter 270, the display 220 may display voice guide information on at least a portion of a display item where a cursor is located.

The communicator 230 communicates with various types of external apparatuses (e.g., an external server) according to various types of communication methods. The communicator 230 may include various communication chips such as a WiFi chip, a Bluetooth chip, a near field communication (NFC) chip, a wireless communication chip, etc. In this case, the WiFi chip, the Bluetooth chip, and the NFC chip perform communication according to a WiFi method, a Bluetooth method, and an NFC method, respectively. Among the above chips, the NFC chip represents a chip which operates according to an NFC method which uses 13.56 MHz band among various radio frequency identification (RFID) frequency bands such as 135 kHz, 13.56 MHz, 433 MHz, 860-960 MHz, 2.45 GHz, etc. In the case of the WiFi chip or the Bluetooth chip, various connection information such as a service set identifier (SSID) and a session key may be first transmitted and/or received for communication connection and various information may be transmitted and/or received through the connected communication. The wireless communication chip represents a chip which performs communication according to various communication standards such as IEEE, Zigbee, 3rd generation (3G), 3rd generation partnership project (3GPP), long term evolution (LTE), etc.

In particular, the communicator 230 may transmit an information request to an external server, and receive information data in response to the information request.

The audio outputter 240 may output audio data which is produced by processing input image data. In this case, the audio outputter 240 may be realized as, for example, at least one of a speaker, a headphone output terminal, and a Sony/Philips digital interface format (S/PDIF) output terminal.

The storage 250 stores various modules to drive the display apparatus 200. For example, the storage 250 may store software including a base module, a sensing module, a communication module, a presentation module, a web browser module, and a service module. In this case, the base module refers to a basic module which processes a signal transmitted from each hardware included in the display apparatus 200, and transmits the processed signal to an upper layer module. The sensing module is a module which collects information from various sensors, and analyzes and manages the collected information. The sensing module may include a face recognition module, a voice recognition module, a motion recognition module, and an NFC recognition module, etc. The presentation module is a module to compose a display screen. The presentation module includes a multimedia module for reproducing and outputting multimedia contents, and a user interface (UI) rendering module for UI and graphic processing. The communication module is a module to perform communication with outside. The web browser module refers to a module which accesses a web server by performing web-browsing. The service module is a module including various applications for providing various services.

In addition, the storage 250 may store a voice database and a motion database. The voice database refers to a database where a voice and a voice task matching with each voice are recorded. The motion database refers to a database where a motion and a motion task matching with each motion are recorded. Herein, the voice task and the motion task of the display apparatus 200 refer to a function which may be performed by the display apparatus 200, such as a channel change, a volume change, web browsing, etc.

The voice inputter 260 receives a voice uttered by a user. The voice inputter 260 converts an input voice signal to an electrical signal and outputs the converted electrical signal to the controller 290. For example, the voice inputter 260 may be realized as a microphone.

The motion inputter 270 receives an image signal (for example, consecutive frames) which is generated by photographing a user motion and provides the received image signal to the controller 290. In this case, the motion inputter 270 may be realized as a camera comprising a lens and an image sensor.

The voice inputter 260 and the motion inputter 270 may be located at an upper middle area of a bezel which is located in an exterior of the display 220, but this is only an example. The voice inputter 260 and the motion inputter 270 may be located at another area, and may be provided separately. When the voice inputter 260 and the motion inputter 270 are separated, the separated voice inputter 260 and the motion inputter 270 may be connected to the display apparatus 200.

The inputter 280 may receive a user command to control the display apparatus 200 except for the voice inputter 260 and the motion inputter 270. For example, the inputter 280 may be realized as a remote controller, and may also be realized as a touch screen, a pointing device, a keyboard, a mouse, etc.

The controller 290 controls overall operations of the display apparatus 200 according to a user command input to the voice inputter 260, the motion inputter 270, and the inputter 280.

In particular, the controller 290 may recognize a user voice input through the voice inputter 260 using the voice recognition module and the voice database stored in the storage 250. Specifically, voice recognition may include isolated word recognition which recognizes an uttered voice by each word, continuous speech recognition which recognizes continuous words, continuous sentences, and a conversational voice, and keyword spotting which is a recognition form between the isolated word recognition and the continuous speech recognition and detects and recognizes a predetermined key word. When a user voice is input, the controller 290 determines a voice section by detecting a start and an end of the user voice (i.e., an uttered voice of a user) within an input voice signal. The controller 290 may calculate energy of the input voice signal, categorize an energy level of the input voice signal based on the calculated energy, and detect a voice section through dynamic programming. The controller 290 generates phoneme data by detecting a phoneme, which is the smallest unit of a voice, from the detected voice section within the input voice signal based on an acoustic model. The controller 290 generates text information by applying a hidden markov model (HMM) to the generated phoneme data. Accordingly, the controller 290 may recognize a user voice included in a voice signal. In the above exemplary embodiment, a user voice is recognized using the display apparatus 200, but this is only an example. A user voice may be recognized using, for example, an external server.

In addition, the controller 290 may recognize a user motion input through the motion inputter 270 using the motion recognition module and the motion database stored in the storage 250. Motion recognition may be performed as an image (for example, consecutive frames) corresponding to a user motion input through the motion inputter 270. The image includes a background area and a hand area (for example, a motion of opening and closing a first) and continuous motions of the hand of the user are recognized. When a user motion is input, the controller 290 stores a received image by a frame unit and senses an object of the user motion (for example, the hand of the user) using stored frames. The motion recognition module detects an object by sensing at least one of a shape, a color, and movement of the object included in the stored frames. The controller 290 may trace the movement of the detected object. In addition, the controller 290 may remove noise from the image of the object except for the movement of the object.

The controller 290 determines a motion according to the shape and the traced movement of an object. The controller 290 determines a user motion by determining changes in a shape, a speed, a location, and a direction of an object. The user motion includes a grab motion where a first is closed, a pointing motion where a displayed cursor is moved by a hand, a slap motion where a hand is moved in a direction at a speed faster than a predetermined speed, a shake motion where a hand is shaken to the left, right, up, or down, and a rotation motion where a hand is rotated. Exemplary embodiments may be applied to motions other than the above examples. For example, an opening motion where a closed first is opened may be further included.

As described above, the controller 290 performs a task of the display apparatus 200 using a recognized voice and motion. In particular, when a predetermined user motion is input through the motion inputter 270 while a cursor is located at one of at least one display item, the controller 290 may control the display 220 to display voice guide information corresponding to a display item where the cursor is located. When a user voice is input based on the displayed voice guide information through the voice inputter 260 while the predetermined user motion is maintained, the controller 290 may control a display item according to the input user voice.

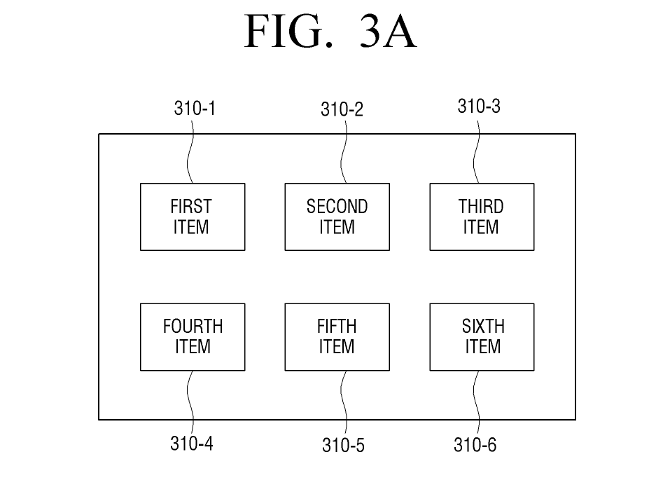

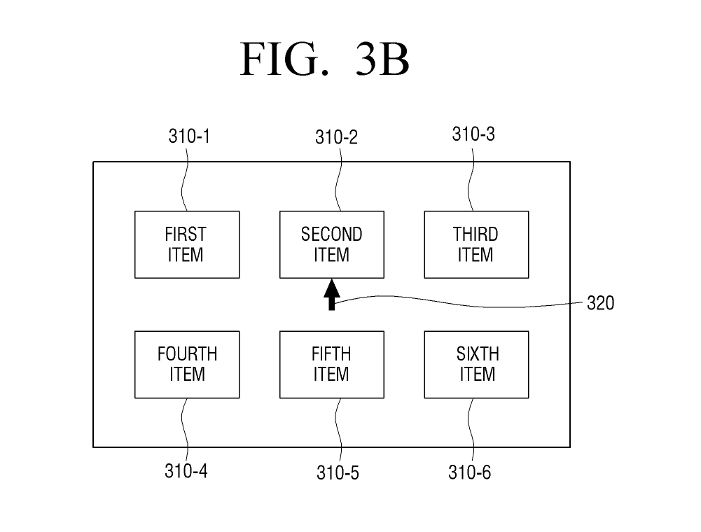

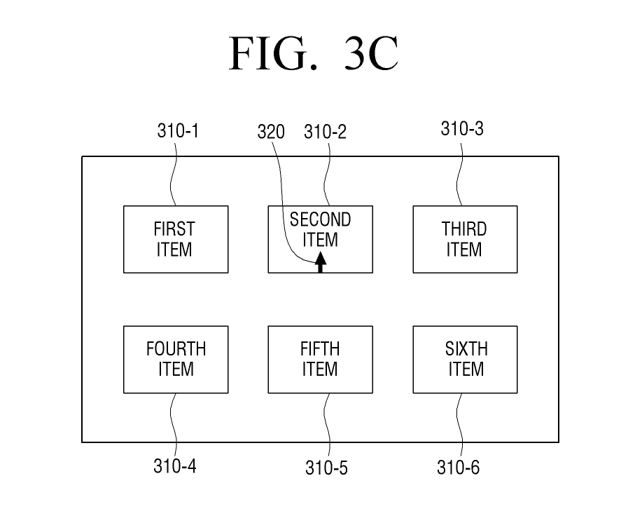

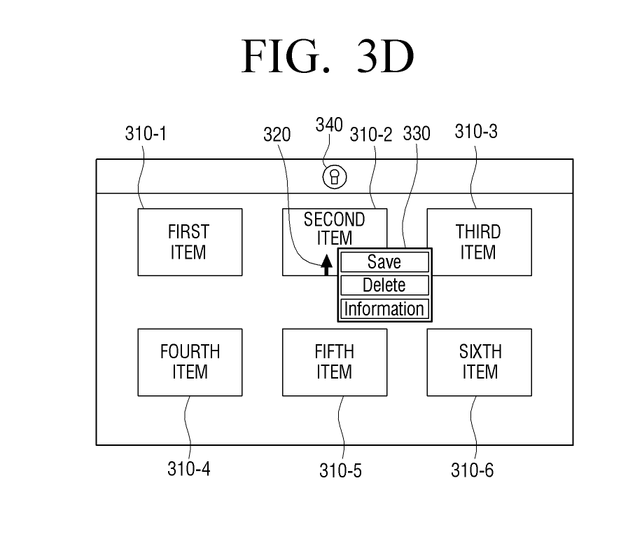

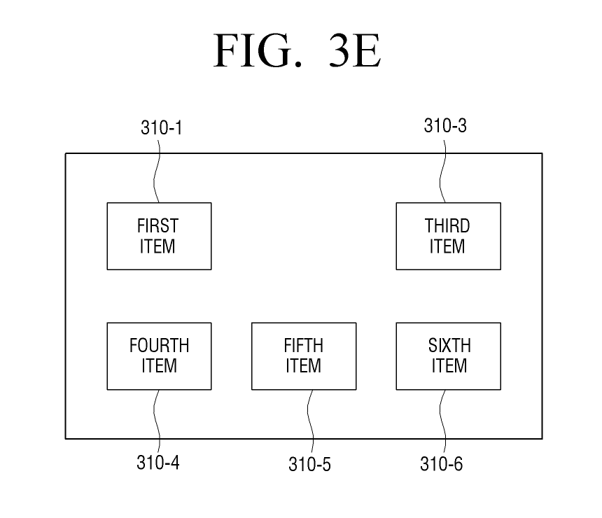

Hereinafter, various exemplary embodiments will be described with reference to FIGS. 3A to 3E. FIGS. 3A to 3E are views for explaining a method for controlling an item included in a list according to an exemplary embodiment.

As illustrated in FIG. 3A, the controller 290 may control the display 220 to display a list of a plurality of items 310-1˜310-6.

When a user motion (for example, a motion of shaking the user's hand to the left and right a plurality of times) to initiate a motion task mode is input while the plurality of items 310-1˜310-6 are displayed, the controller 290, as illustrated in FIG. 3B, may control the display 220 to display a cursor 320 on an area of a display screen.

When a user motion to move the cursor 320 is input through the motion inputter 270, the controller 290 may move the cursor 320 according to the user motion. For example, when a user motion (for example, a motion of moving the user's hand upwardly) to move the cursor 320 in an upper direction is input through the motion inputter 270, the controller 290, as illustrated in FIG. 3C, may control the display 220 to move the cursor 320 so that the cursor 320 is located at a second item 310-2.

When a user motion, e.g., a pinch motion is input while the cursor 320 is located at the second item 310-2, the controller 290 may control the display 220 to display, as the voice guide information, a voice guide list 330 including a text item to control the second item 310-2 on at least a portion of the second item 310-2, as illustrated in FIG. 3D. In this case, the voice guide list 330 may include items such as “save”, “delete”, and “information”.

In addition, the controller 290 may control the display 220 to display an indicator 340 indicating that it is possible to perform voice recognition on at least a portion of the display screen, e.g., an upper portion of the display screen along with the voice guide list 330. In this case, the indicator 340 may be an icon in a form of a microphone, as illustrated in FIG. 3D.

When a user motion, e.g., a pinch motion is input, the controller 290 may apply power to the voice inputter 260. That is, power may not be applied to the voice inputter 260 in a general state. By controlling the display apparatus 100 such that power is applied to the voice inputter 260 in response to a user motion, e.g., a pinch motion, stand-by power may be reduced.

When a user voice of “delete” among text items included in the voice guide list 330 is input through the voice inputter 260 while a pinch motion is maintained, the controller 290 may recognize the user voice, and as illustrated in FIG. 3E, may remove the second item 310-2 from the display screen according to the recognized user voice.

On the other hand, when a pinch motion is released before a user voice corresponding to the item of “delete” is input, the controller 290 may control the display 220 to remove the voice guide list 330 such that the display 220 may display a screen as illustrated in FIG. 3C.

As described above, a user may control an item more conveniently using a user voice and a user motion.

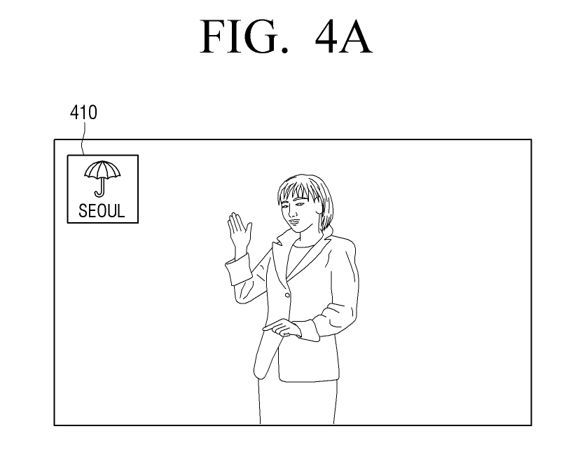

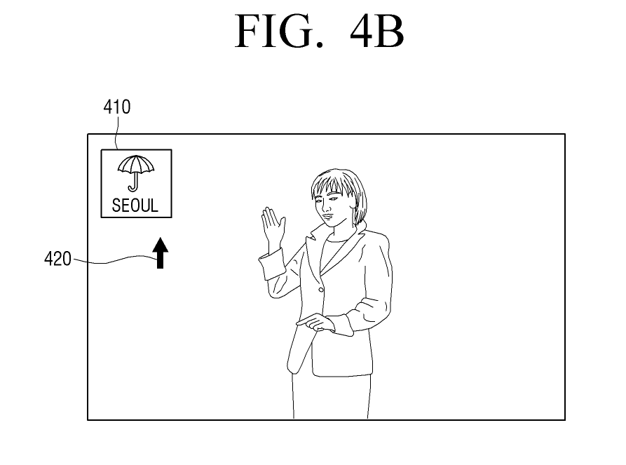

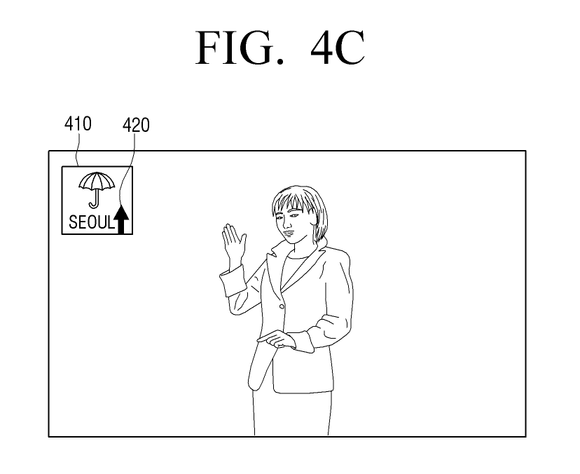

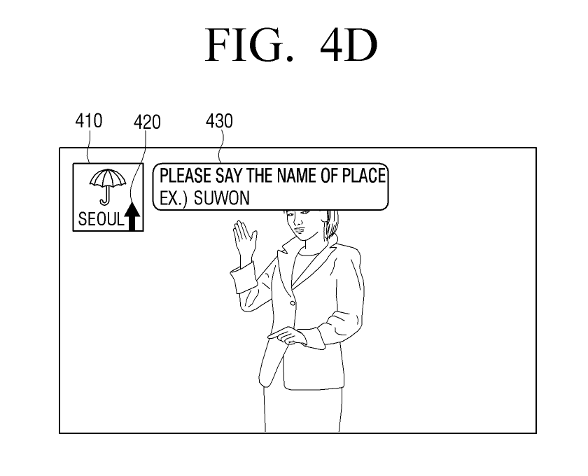

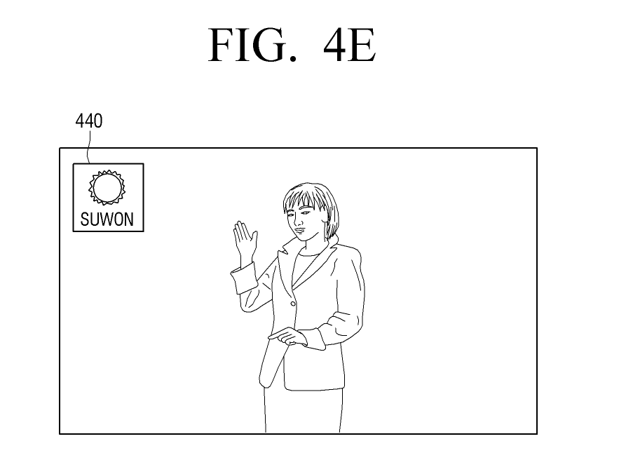

FIGS. 4A to 4E are views for explaining a method for controlling an information providing widget using a user motion and a user voice according to an exemplary embodiment.

As illustrated in FIG. 4A, the controller 290 may control the display 220 to display a weather widget 410 for providing weather information on an upper left portion of a display screen.

When a user motion (for example, a motion of shaking a user's hand to the left and right a plurality of times) to initiate a motion task mode is input while the weather widget 410 is displayed, the controller 290, as illustrated in FIG. 4B, may control the display 220 to display a cursor 420 on a portion of the display screen.

When a user motion to move the cursor 420 is input through the motion inputter 270, the controller 290 may move the cursor 420 corresponding to the user motion. For example, when a user motion (for example, a motion of moving a user's hand to an upper direction) to move the cursor 420 to the upper direction is input through the motion inputter 270, the controller 290, as illustrated in FIG. 4C, may control the display 220 to move the cursor 420 in the upper direction so that the cursor 420 is located at the weather widget 410.

When a user motion, e.g., a pinch motion is input while the cursor 420 is located at the weather widget 410, the controller 290 may control the display 220 to display voice guide information 430 for guiding a user voice to provide whether information of another place, as shown in FIG. 4D. In this case, the voice guide information 430 may display a guidance message such as “please say the name of place. EX.) Suwon”.

In an exemplary embodiment, when a pinch motion is input, the controller 290 may apply power to the voice inputter 260. That is, power may not be applied to the voice inputter 260 in a general state. By controlling the display apparatus 100 such that power is applied to the voice inputter 260 in response to a user motion, e.g., a pinch motion, stand-by power may be reduced.

When a user voice corresponding to “Suwon” is input through the voice inputter 260 while a pinch motion is maintained, the controller 290 may recognize the user voice, and control the communicator 230 to transmit a request signal regarding weather information of Suwon to an external server. When the weather information of Suwon is received from the server, the controller 290, as illustrated in FIG. 4E, may control the display 220 to display a weather widget 440 to include weather information of Suwon.

On the other hand, when a pinch motion is released before a user voice is input, the controller 290 may control the display 220 to remove the voice guide information 430 such that the display 220 may display a screen as illustrated in FIG. 4C.

As described above, a user may be provided with various information through a widget more easily and swiftly by using a user voice and a user motion.

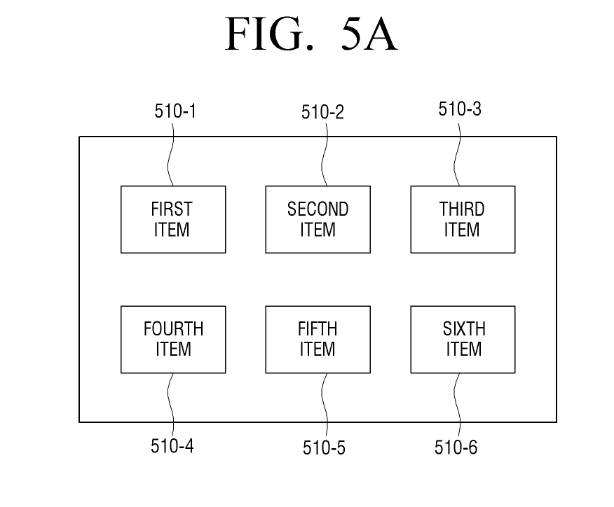

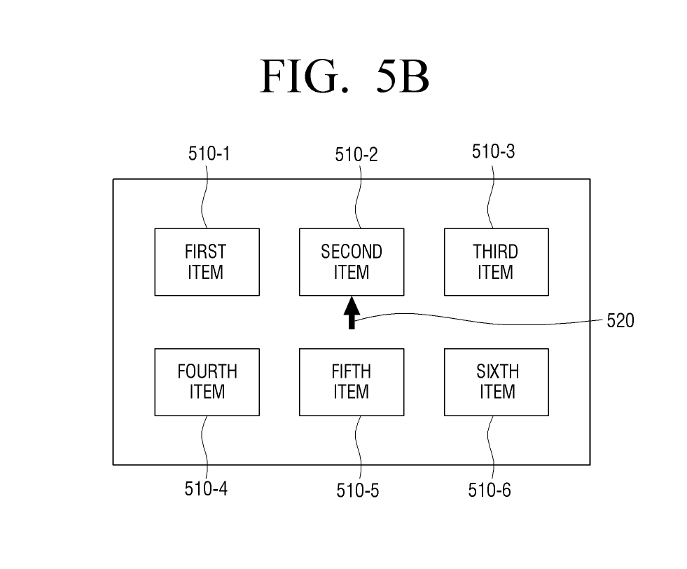

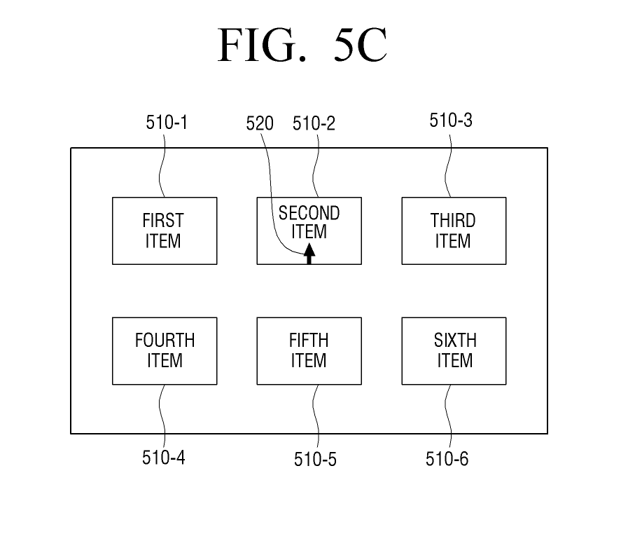

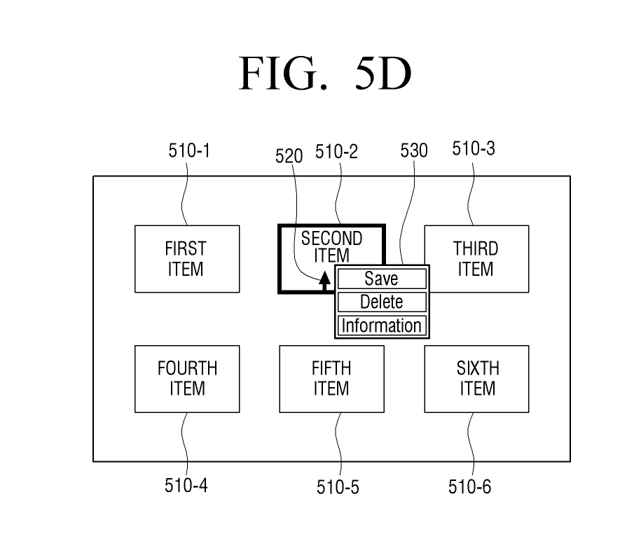

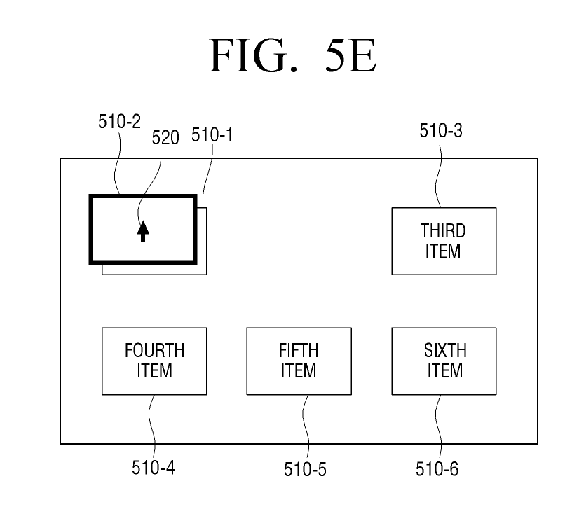

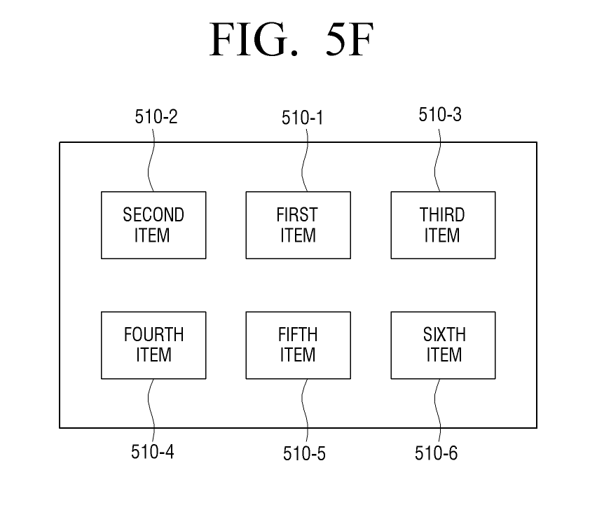

In the above exemplary embodiment, a display item is controlled using both a user voice and a user motion. However, it should be noted that a display item may be controlled using at least one from among a user motion and a user motion according to exemplary embodiments. For example, a display item may be controlled by using only a user motion. Hereinafter, a method for controlling a display item using a user motion will be described with reference to FIGS. 5A to 5F.

FIGS. 5A to 5F are views for explaining a method for controlling a display item using a user motion according to another exemplary embodiment.

As illustrated in FIG. 5A, the controller 290 may control the display 220 to display a list comprising a plurality of items 510-1˜510-6.

When a user motion (for example, a motion of shaking a user's hand to the left and right a plurality of times) to initiate a motion task mode is input while the plurality of items 510-1˜510-6 are displayed, the controller 290, as illustrated in FIG. 5B, may control the display 220 to display a cursor 520 on a portion of a display screen.

When a user motion to move the cursor 520 is input through the motion inputter 270, the controller 290 may move the cursor 520 according to the user motion. For example, when a user motion (for example, a motion of moving a user's hand in an upper direction) to move the cursor 520 in the upper direction is input through the motion inputter 270, the controller 290, as illustrated in FIG. 5C, may control the display 220 to move the cursor 520 in the upper direction so that the cursor 520 is located at a second item 510-2.

When a user motion, e.g., a pinch motion is input for a predetermined time (for example, about 3 seconds) while the cursor 520 is located at the second item 510-2, the controller 290 may enter a motion editing mode, and as illustrated in FIG. 5D, may control the display 220 to display an editing list 530 to control the second item 510-2 on a portion of the second item 510-2. In this case, the editing list 530 may include items such as “save”, “delete”, and “information”.

In this case, to inform the user that the second item 510-2 is selected for editing, the controller 290, as illustrated in FIG. 5D, may control the display 220 to highlight the second item 510-2.

In addition, when a pinch motion is input for a predetermined time, the controller 290 may provide a graphic user interface (GUI) effect with respect to the cursor 520. For example, when a pinch motion is input for a predetermined time, the controller 290 may control the display 220 to gradually change a color of the cursor 520 to be displayed.

When a user motion of moving a user's hand in a left direction is input while a pinch motion is maintained, the controller 290, as illustrated in FIG. 5E, may control the display 220 to move the selected second item 510-2 in the left direction so that the second item 510-2 is located at the first item 510-1.

When a pinch motion is released after the second item 510-2 is moved to be located at a left side of the first item 510-1, the controller 290, as illustrated in FIG. 5F, may control the display 220 to display the second item 510-2 on an area where the first item 510-1 was previously displayed and to display the first item 510-1 on an area where the second item 510-2 was previously displayed. That is, positions of the first item 510-1 and the second item 510-2 may be switched to each other.

According to the above-described exemplary embodiment, a user may move a display item to a desired position using a user motion.

In an alternative embodiment, when the second item 510-2 is moved beyond an area of the list comprising the plurality of items 510-1˜510-6, the controller 290 may remove the second item 510-2 from the display screen.

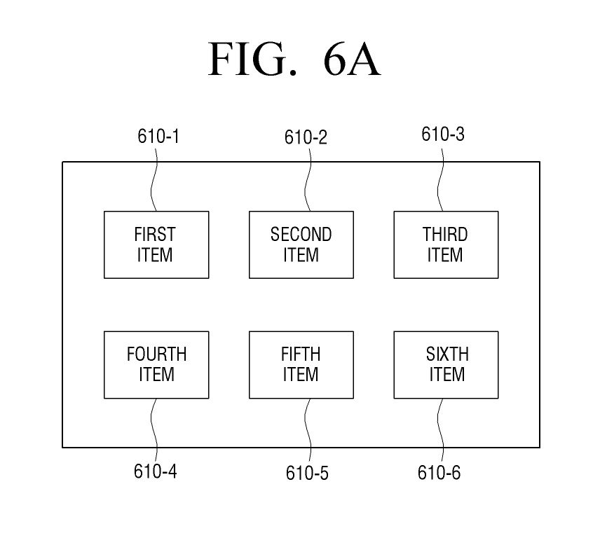

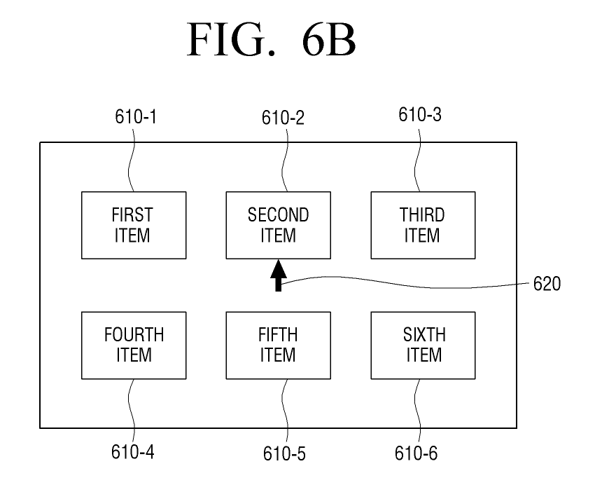

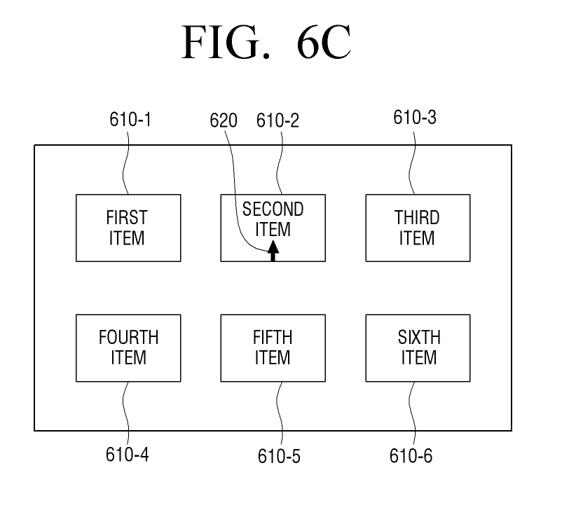

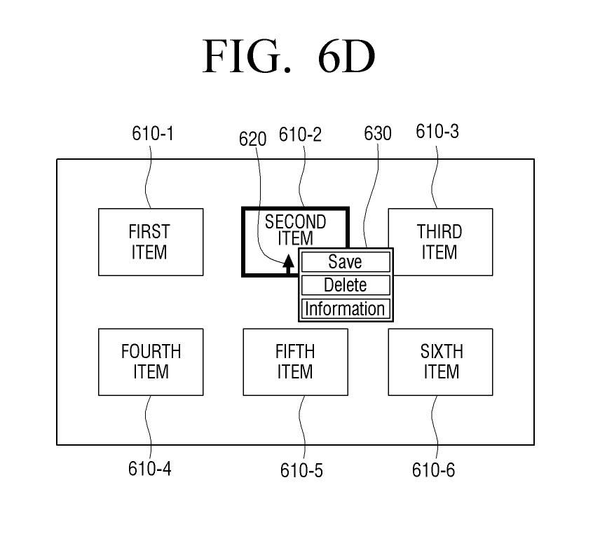

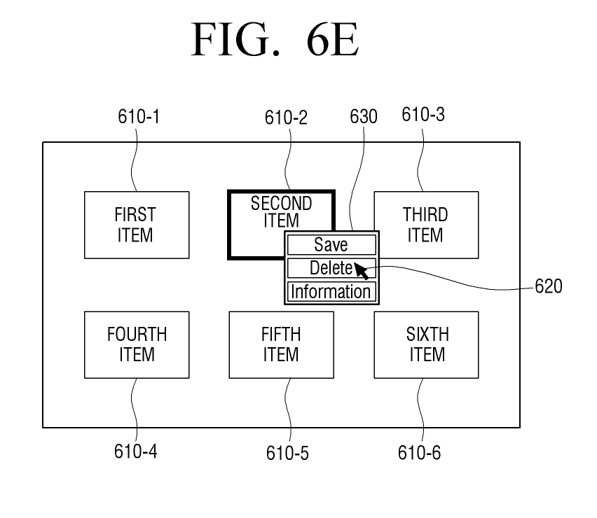

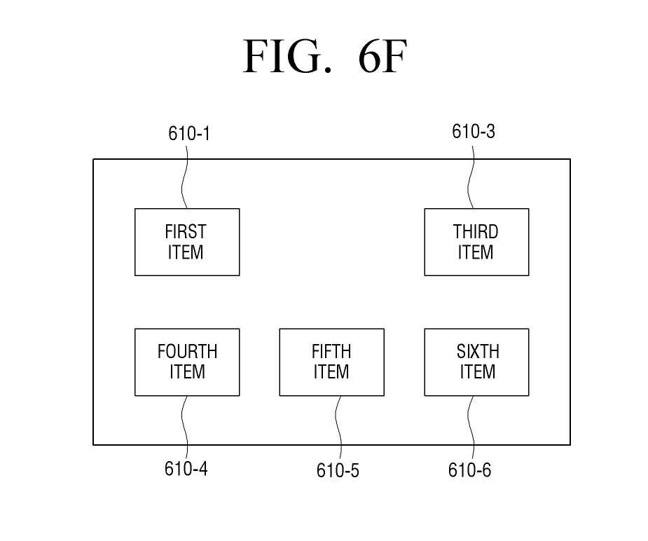

FIGS. 6A to 6F are views for explaining a method for controlling an item included in a list using a user motion according to still another exemplary embodiment.

As illustrated in FIG. 6A, the controller 290 may control the display 220 to display a list comprising a plurality of items 610-1˜610-6.

When a user motion (for example, a motion of shaking a user's hand left and right a plurality of times) to initiate a motion task mode is input while the plurality of items 610-1˜610-6 are displayed, the controller 290, as illustrated in FIG. 6B, may control the display 220 to display a cursor 620 on a portion of a display screen.

When a user motion to move the cursor 620 is input through the motion inputter 270, the controller 290 may move the cursor 620 according to the user motion. For example, when a user motion (for example, a motion of moving a user's hand in an upper direction) to move the cursor 620 in an upper direction is input through the motion inputter 270, the controller 290, as illustrated in FIG. 6C, may control the display 220 to move the cursor 620 in the upper direction so that the cursor 620 is located at a second item 610-2.

When a user motion, e.g., a pinch motion is input for a predetermined time (for example, about 3 seconds) while the cursor 620 is located at the second item 610-2, the controller 290 may enter a motion editing mode, and as illustrated in FIG. 6D, may control the display 220 to display an editing list 630 to control the second item 610-2 on a portion of the second item 610-2. In this case, the editing list 630 may include items such as “save”, “delete”, and “information”.

In this case, to inform the user that the second item 610-2 is selected for editing, the controller 290, as illustrated in FIG. 6D, may control the display 220 to highlight the second item 610-2.

In addition, when a pinch motion is input for a predetermined time, the controller 290 may provide a GUI effect with respect to the cursor 620. For example, when a pinch motion is input for a predetermined time, the controller 290 may control the display 220 to gradually change the color of the cursor 620 to be displayed.

When a user motion of moving the cursor 620 to one of a plurality of items included in the editing list 630 is input within a predetermined time after a pinch motion is released, the controller 290, as illustrated in FIG. 6E, may move the cursor 620 to the item of “delete” in the editing list 630.

When a user motion (for example, a grab motion) to select an item is input while the cursor 620 is located at the item of “delete” in the editing list 630, the controller 290, as illustrated in FIG. 6F, may control the display 220 to remove the second item 610-2 from the display screen.

According to the above-described exemplary embodiment, a user may control a display item using a user motion.

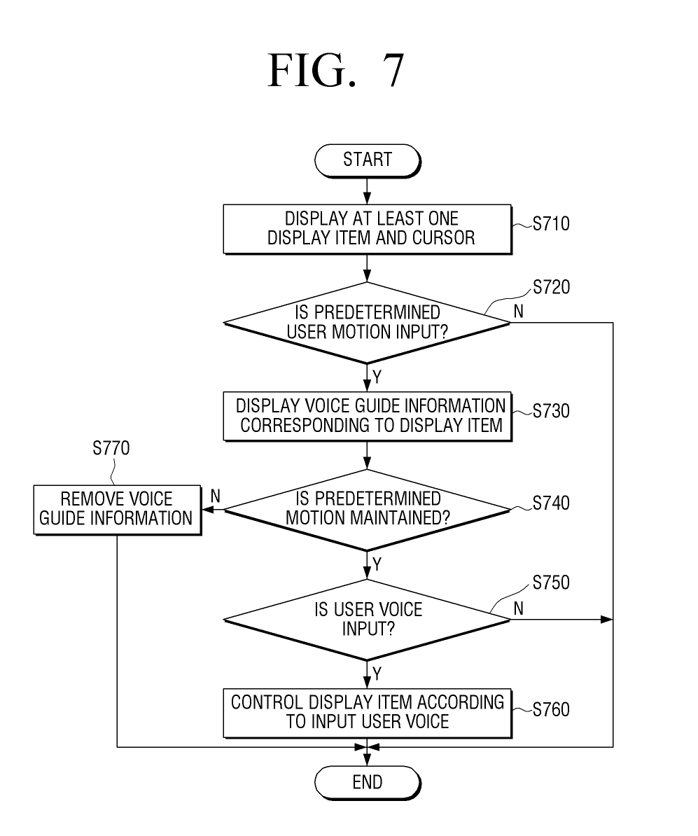

Hereinafter, a method for controlling the display apparatus 100 according to an exemplary embodiment will be described with reference to FIG. 7.

The display apparatus 100 displays at least one display item and a cursor (S710). In an exemplary embodiment, the display apparatus 100 may display a display item first, and when a motion start command to perform a motion task mode is input, a cursor may be further displayed.

The display apparatus 100 determines whether a predetermined user motion is input (S720). In this case, the predetermined user motion may be, for example, a pinch or grab motion.

When the predetermined user motion is input (‘Yes’ to S720), the display apparatus 100 displays voice guide information corresponding to a display item (S730). In this case, when the display item is an item included in a list, the voice guide information may include at least one text item. When the at least one display item is a widget for providing information, the voice guide information may include a message for guiding a user voice to provide other information.

Subsequently, the display apparatus 100 determines whether the predetermined user motion is maintained (S740).

When the predetermined user motion is not maintained (‘No’ to S740), the display apparatus 100 removes the voice guide information from the display screen (S750).

When the predetermined user motion is maintained (‘Yes’ to S740), the display apparatus 100 determines whether a user voice is input (S750). In this case, when the display item is an item included in the list, the user voice may be matched with a text item included in the voice guide information, and when the display item is a widget, the user voice may be related to information that the user wishes to search.

When the user voice is input (‘Yes’ to S750), the display apparatus 100 controls the display item according to the input user voice (S760). For example, the display apparatus 100 may perform a function such as removing the display item from the display screen, storing the display item, or requesting detailed information according to the user voice.

When the predetermined user motion is not input (‘No’ to S720) or the user voice is not input (‘No’ to S750), the method for controlling the display apparatus 100 is terminated.

By using the above-described controlling method of the display apparatus according to exemplary embodiments, a user may control a display item more easily and intuitively.

Exemplary embodiments may also be implemented through computer-readable recording media having recorded thereon computer-executable instructions such as program modules that are executed by a computer. Computer-readable media may be any available media that can be accessed by a computer and include both volatile and nonvolatile media and both detachable and non-detachable media. Examples of the computer-readable media may include a read-only memory (ROM), a random-access memory (RAM), a compact disc (CD)-ROM, a magnetic tape, a floppy disk, an optical data storage device, etc. Furthermore, the computer-readable media may include computer storage media and communication media. The computer storage media include both volatile and nonvolatile and both detachable and non-detachable media implemented by any method or technique for storing information such as computer-readable instructions, data structures, program modules or other data. The communication media typically embody computer-readable instructions, data structures, program modules, other data of a modulated data signal such as a carrier wave, or other transmission mechanism, and they include any information transmission media

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. A method for controlling a display apparatus, the method comprising:
displaying at least one display item and a cursor on a display screen;
when a predetermined user motion is input while the cursor is located at one of the at least one display item, displaying voice guide information corresponding to the one of the at least one display item where the cursor is located; and
when a user voice is input based on the voice guide information while the predetermined user motion is maintained, controlling the one of the at least one display item according to the input user voice.

2. The method as claimed in claim 1, wherein, when the one of the at least one display item is an item among a plurality of items included in a list, the voice guide information includes at least one text item to control the item.

3. The method as claimed in claim 2, wherein the controlling comprises, when a user voice which matches with one of the at least one text item included in the voice guide information is input while the predetermined user motion is maintained, controlling the one of the at least one display item according to the one of the at least one text item.

4. The method as claimed in claim 1, wherein, when the one of the at least one display item is a widget for providing information, the voice guide information includes a message for guiding a user to control the widget to provide another information.

5. The method as claimed in claim 4, comprising:
when the user voice is input based on the voice guide information while the predetermined user motion is maintained, transmitting the user voice to an external server; and
when information corresponding to the user voice is received from the server, displaying the received information through the widget.

6. The method as claimed in claim 1, further comprising:
when the predetermined user motion is released, removing the voice guide information from the display screen.

7. The method as claimed in claim 1, wherein the displaying the voice guide information comprises, when the predetermined user motion is maintained for a predetermined time while the cursor is located at the one of the at least one display item, applying power to a voice input apparatus and displaying the voice guide information corresponding to the one of at least one display item where the cursor is located.

8. The method as claimed in claim 1, wherein the displaying the at least one display item and the cursor comprises:
displaying the at least one display item; and
when a user motion for operating a motion task mode is input, displaying the cursor on the display screen.

9. The method as claimed in claim 1, wherein the displaying the voice guide information comprises displaying an indicator for indicating that the user voice is recognizable on at least a portion of the display screen.

10. The method as claimed in claim 1, wherein the predetermined user motion is a pinch or grab motion.

11. A display apparatus, comprising:
a display configured to display at least one display item and a cursor on a display screen;
a motion inputter configured to receive a user motion;
a voice inputter configured to receive a user voice; and
a controller configured to, when a predetermined user motion is input through the motion inputter while the cursor is located at one of the at least one display item, control the display to display voice guide information corresponding to the one of the at least one display item where the cursor is located, and when a user voice is input based on the voice guide information through the voice inputter while the predetermined user motion is maintained, control the one of the at least one display item according to the input user voice.

12. The display apparatus as claimed in claim 11, wherein, when the one of the at least one display item is an item among a plurality of items included in a list, the voice guide information includes at least one text item to control the item.

13. The display apparatus as claimed in claim 12, wherein the controller, when a user voice which matches with one of the at least one text item included in the voice guide information is input through the voice inputter while the predetermined user motion is maintained, controls the one of the at least one display item according to the one of the at least one text item.

14. The display apparatus as claimed in claim 11, wherein, when the one of the at least one display item is a widget for providing information, the voice guide information includes a message for guiding a user to control the widget to provide another information.

15. The display apparatus as claimed in claim 14, further comprising:
a communicator,
wherein the controller, when the user voice is input based on the voice guide information through the voice inputter while the predetermined user motion is maintained, controls the communicator to transmit the user voice to an external server, and when information corresponding to the user voice is received from the external server, controls the display to display the received information through the widget.

16. The display apparatus as claimed in claim 11, wherein the controller, when the predetermined user motion is released, controls the display to remove the voice guide information from the display screen.

17. The display apparatus as claimed in claim 11, wherein the controller, when the predetermined user motion is maintained for a predetermined time while the cursor is located at the one of the at least one display item, controls the display to apply power to the voice inputter and display the voice guide information corresponding to the one of the at least one display item where the cursor is located.

18. The display apparatus as claimed in claim 11, wherein the controller controls the display to display the at least one display item, and when a user motion for operating a motion task mode is input, to display the cursor on the display screen.

19. The display apparatus as claimed in claim 11, wherein the controller controls the display to display an indicator for indicating that the user voice is recognizable on at least a portion of the display screen.

20. The display apparatus as claimed in claim 11, wherein the predetermined user motion is a pinch or grab motion.
